(19) United States
(12) Patent Application Publication
(10) Pub. No.: US 2026/0189815 A1
(43) Pub. Date: Jul. 2, 2026

(54) IMAGE SENSING DEVICE

(71) Applicant: Samsung Electronics Co., Ltd., Suwon-si (KR)

(72) Inventors: Kyung-Min Kim, Suwon-si (KR); Young Tae Jang, Suwon-si (KR); Min-Sun Keel, Suwon-si (KR)

(21) Appl. No.: 19/414,377

(22) Filed: Dec. 10, 2025

(30) Foreign Application Priority Data
Jan. 2, 2025 (KR) 10-2025-0000264

(51) Int. Cl. H04N 25/59; H04N 25/709; H04N 25/76

(52) U.S. Cl. CPC H04N 25/59; H04N 25/709; H04N 25/7795

(57) ABSTRACT

Image sensing devices are provided. In one aspect, an image sensing device includes a plurality of pixels, wherein each of the plurality of pixels includes a first photodiode, a transfer transistor connected to the first photodiode and a first floating diffusion (FD) node, a conversion gain transistor connected to the first FD node and a second FD node and providing charges in the first FD node to the second FD node, a first capacitor connected to the second FD node and storing charges provided from the second FD node, a connection transistor connected to the second FD node and a third FD node and providing the charges in the second FD node to the third FD node, a second capacitor connected to the third FD node and a first power supply voltage, storing the charges provided from the third FD node, and a reset transistor providing a reset voltage.

### CROSS-REFERENCE TO RELATED APPLICATION

This application claims priority to Korean Patent Application No. 10-2025-0000264 filed on Jan. 2, 2025, in the Korean Intellectual Property Office, and all the benefits accruing therefrom under 35 U.S.C. 119, the contents of which in its entirety are herein incorporated by reference.

### BACKGROUND

An image sensing device is a semiconductor device that converts optical information into an electrical signal. The image sensing device may include a complementary metal-oxide semiconductor (CMOS) image sensor. The image sensor may include a plurality of pixels that are two-dimensionally arranged. Each pixel may include at least one photodiode. Each photodiode converts an amount of incident light into an electrical signal.

Recently, the image sensor has been actively used not only for mobile devices including smartphones, but also for surveillance cameras and vehicles. The image sensor needs to secure a high dynamic range in order to well express the brightest and darkest areas in a single image at the same time. In particular, efforts are being made to obtain images of a high dynamic range in order to simultaneously express a high lumination environment in which the sun is strong and a low lumination environment such as a tunnel.

### SUMMARY

Aspects of the present disclosure provide an image sensing device capable of securing an image of a high dynamic range.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some implementations of present disclosure, an image sensing device comprises a plurality of pixels, wherein each of the plurality of pixels includes a first photodiode, a transfer transistor having one end connected to the first photodiode and the other end connected to a first floating diffusion (FD) node and providing charges generated in the first photodiode to the first FD node in response to a transfer control signal, a conversion gain transistor having one end connected to the first FD node and the other end connected to a second FD node and providing charges in the first FD node to the second FD node in response to a conversion gain control signal, a first capacitor connected to the second FD node and storing charges provided from the second FD node, a connection transistor having one end connected to the second FD node and the other end connected to a third FD node and providing the charges in the second FD node to the third FD node in response to a connection control signal, a second capacitor having one end connected to the third FD node and the other end connected to a first power supply voltage, storing the charges provided from the third FD node, and having a larger capacitance than the first capacitor, and a reset transistor providing a reset voltage to at least one of the first to third FD nodes and the first and second capacitors.

According to some implementations of present disclosure, an image sensing device comprises a plurality of pixels, wherein each of the plurality of pixels includes a first photodiode, first to third floating diffusion (FD) nodes, a first capacitor, and a second capacitor having a larger capacitance than the first capacitor, and each of the plurality of pixels sequentially outputs a first reset signal, a second reset signal, a first sub-output signal corresponding to the second reset signal and obtained by converting charges in the first FD node with a first conversion gain, a second sub-output signal corresponding to the first reset signal and obtained by converting charges in the first and second FD nodes with a second conversion gain smaller than the first conversion gain, a third sub-output signal obtained by converting charges in the first and second FD nodes and the first capacitor with a third conversion gain that is the same as the second conversion gain, a fourth sub-output signal obtained by converting charges in the first FD node, the second FD node, the third FD node, and the first and second capacitors with a fourth conversion gain smaller than the third conversion gain, a third reset signal corresponding to the fourth sub-output signal, and a fourth rest signal corresponding to the third sub-output signal.

According to some implementations of present disclosure, an image sensing device comprising a plurality of pixels, wherein each of the plurality of pixels includes a first photodiode, a transfer transistor having one end connected to the photodiode and the other end connected to a first floating diffusion (FD) node, a conversion gain transistor having one end connected to the first FD node and the other end connected to a second FD node, a first capacitor connected to the second FD node and storing charges provided from the second FD node, a connection transistor having one end connected to the second FD node and the other end connected to a third FD node, and a second capacitor having one end connected to the third FD node and the other end connected to a first power supply voltage and storing charges provided from the third FD node, each of the plurality of pixels sequentially outputs a first reset signal, a second reset signal, a first sub-output signal corresponding to the second reset signal and obtained by converting charges in the first FD node with a first conversion gain, a second sub-output signal corresponding to the first reset signal and obtained by converting charges in the first and second FD nodes with a second conversion gain smaller than the first conversion gain, a third sub-output signal obtained by converting charges in the first and second FD nodes and the first capacitor with a third conversion gain that is the same as the second conversion gain, a fourth sub-output signal obtained by converting charges in the first FD node, the second FD node, the third FD node, and the first and second capacitors with a fourth conversion gain smaller than the third conversion gain, a third reset signal corresponding to the fourth sub-output signal, and a fourth rest signal corresponding to the third sub-output signal.

The details of other implementations are included in the detailed description and drawings.

### BRIEF DESCRIPTION OF THE DRAWINGS

The above and other aspects and features of the present disclosure will become more apparent by describing in detail exemplary implementations thereof with reference to the attached drawings, in which:

FIG. 1 is a block diagram for describing an example of an image sensing device.

FIG. 2 is a circuit diagram for describing an example of one of the pixels of the image sensing device.

FIG. 3 is a timing diagram for describing an example of an operation of the pixel of FIG. 2.

FIG. 4 is a graph illustrating an example of a signal to noise ratio of a pixel according to changes in luminance.

FIG. 5 is a graph illustrating an example of a signal-to-noise ratio of a pixel according to changes in luminance.

FIG. 6 is a circuit diagram for describing an example of one of the pixels of the image sensing device.

FIG. 7 is a timing diagram for describing an example of an operation of the pixel of FIG. 6.

FIG. 8 is a circuit diagram for describing an example of one of the pixels of the image sensing device.

FIG. 9 is a circuit diagram for describing an example of one of the pixels of the image sensing device.

FIG. 10 is a circuit diagram for describing an example of one of the pixels of the image sensing device.

### DETAILED DESCRIPTION

Hereinafter, implementations of the present disclosure will be described with reference to the accompanying drawings.

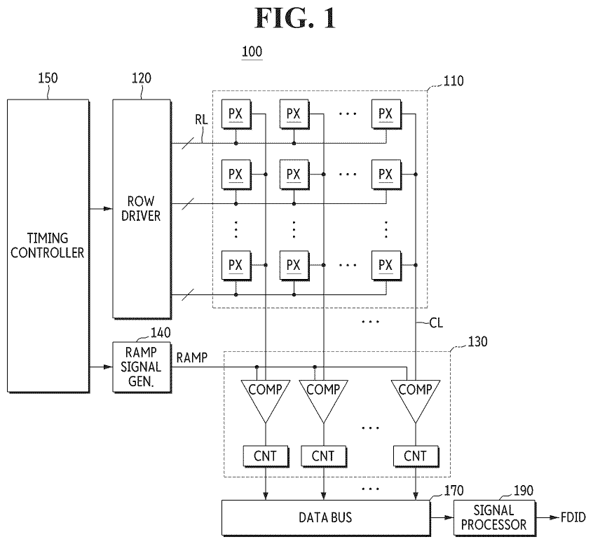

FIG. 1 is a block diagram for describing an image sensing device.

An image sensing device 100 may be mounted on an electronic device having an image or light sensing function. For example, the image sensing device 100 may be mounted on electronic devices such as a camera, a smartphone, a wearable device, an Internet of Things (IoT) device, a home appliance, a tablet personal computer (PC), a personal digital assistant (PDA), a portable multimedia player (PMP), navigation, drone, advanced drivers assistance system (ADAS), and the like. In addition, the image sensing device 100 may be mounted on electronic devices provided as parts, in vehicles, furniture, manufacturing facilities, doors, and various measuring devices.

Referring to FIG. 1, an image sensing device 100 may include a pixel array 110, a row driver 120, an analog-digital conversion circuit 130 (hereinafter, referred to as an ADC circuit), a ramp signal generator 140, a timing controller 150, a data bus 170, and a signal processor 190.

The pixel array 110 may include a plurality of pixels PX arranged in a matrix. The plurality of pixels PX may be connected to a plurality of row lines RL and a plurality of column lines CL. For example, each of the plurality of row lines RL may extend in a row direction and may be connected to pixels PX disposed in the same row. However, unlike as illustrated in FIG. 1, the pixels PX disposed in the same row may be connected to different row lines RL. Each of the plurality of pixels PX may receive a control signal from the row driver 120 through the connected row line RL.

Each of the plurality of pixels PX may include at least one photoelectric conversion element (or a photo-sensing element). The photoelectric conversion element may sense light and convert the sensed light into a photo-charge. For example, the photoelectric conversion element may be a photo-sensing element including organic or inorganic materials, such as an inorganic photodiode, an organic photodiode, a perovskite photodiode, a phototransistor, a photogate, or a pinned photodiode. Each of the plurality of pixels PX may include a plurality of photoelectric conversion elements (hereinafter, referred to as photodiodes). A plurality of photo-charges generated by the photodiode in response to light over a certain exposure time may be called a photo-charge packet. A micro lens for condensing light may be disposed above each of the plurality of pixels PX or above each pixel group including adjacent pixels PX. Each of the plurality of pixels PX may sense light in a specific spectral region from light received through the micro lens. For example, the pixel array 110 may include a red pixel for converting light in a red spectral region into an electrical signal, a green pixel for converting light in a green spectral region into an electrical signal, and a blue pixel for converting light in a blue spectral region into an electrical signal. A color filter for transmitting light in a specific spectral region may be disposed above each of the plurality of pixels PX. However, the pixel array 110 is not limited thereto and may include pixels that convert light in spectral regions other than red, green, and blue into electrical signals.

The image sensing device 100 may include a first semiconductor substrate including the pixel array 110 and a second semiconductor substrate including other blocks 120 to 190 excluding the pixel array. The first semiconductor substrate and the second semiconductor substrate may be stacked on each other and transmit signals to each other through TSV or other connection means penetrating through the first semiconductor substrate. However, the image sensing device 100 is not limited thereto and may include three semiconductor substrates. In this case, the pixel array 110 may include two semiconductor chips.

Each of the plurality of column lines CL may extend in a column direction and may be connected to pixels PX disposed in the same column. However, unlike as illustrated in FIG. 1, the pixels PX disposed in the same column may also be connected to different column lines CL. Each of the plurality of column lines CL may transmit a reset signal and a sub-output signal of pixels PX in a row unit of the pixel array 110 to the ADC circuit 130 and the data bus 170.

The timing controller 150 may control the timing of the row driver 120, the ADC circuit 130, the data bus 170, and the ramp signal generator 140. The timing controller 150 may provide timing signals indicating operation timing for each of the row driver 120, the ADC circuit 130, the data bus 170, and the ramp signal generator 140.

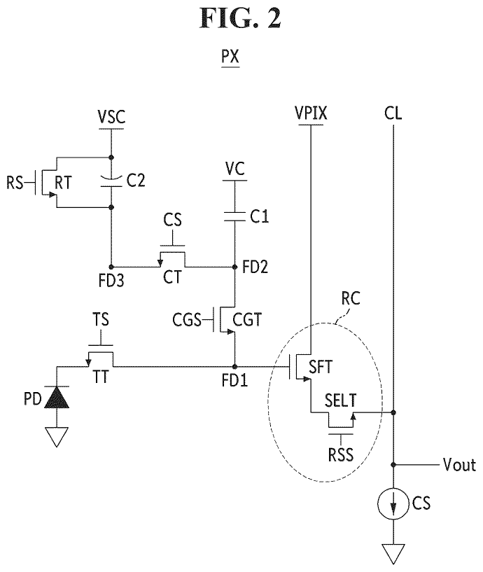

The row driver 120 may generate control signals for driving the pixel array 110 under the control of the timing controller 150, and may provide the control signals to each of the plurality of pixels PX of the pixel array 110 through the plurality of row lines RL. Turn-on and turn-off operations of transistors described later may be performed by the control signals provided from the row driver 120. For example, a first transfer transistor (TT in FIG. 2) may be turned on in response to a first transfer control signal TS having an active level (logic high), and may be turned off in response to a first transfer control signal TS having an inactive level (logic low). The operation of the pixel PX according to the control signals provided from the row driver 120 will be described later.

The row driver 120 may perform control so that the plurality of pixels PX of the pixel array 110 sense light incident simultaneously or in units of rows. In addition, the row driver 120 may perform control so that pixels PX are selected in units of rows among the plurality of pixels PX and the selected pixels PX (e.g., the pixels PX in one row) output (generate) reset signals and sub-output signals through the plurality of column line CL.

The ADC circuit 130 may read out the reset signals and the sub-output signals from the pixels PX in the row selected by the row driver 120 among the plurality of pixels PX. The ADC circuit 130 may generate and output pixel values (image signals) corresponding to the plurality of pixels PX in units of rows by converting the reset signals and the sub-output signals received from the pixel array 110 through the plurality of column lines CL into digital data using a ramp signal RAMP received from the ramp signal generator 140.

The ADC circuit 130 may include a plurality of ADCs corresponding to the plurality of column lines CL, and each of the plurality of ADCs may include a comparator COMP that each compares the reset signal and the sub-output signal received through the corresponding column line CL with the ramp signal RAMP, and a counter CNT that generates a digital code value corresponding to the number of clocks counted based on the comparison results and provides the digital code value to the data bus 170. For example, the ADC circuit 130 may remove the reset signal from the sub-output signal and generate an image signal, i.e., a pixel value representing the amount of light sensed in the pixel PX.

The ADC circuit 130 may generate a pixel signal through the correlated double sampling (CDS) technique. Correlated double sampling is a technique that double samples the reset signal and the sub-output signal in a floating diffusion region to output a difference between the reset signal and the sub-output signal. Among these, a technique of reading out a reset level first and then an output level is a first type of CDS, and a technique of reading out the output level first and then the reset level is a second type of CDS. The first type of CDS is referred to as a complete CDS technique, and the second type of CDS is referred to as an in-complete CDS technique.

The plurality of image signals generated in the ADC circuit 130 may be output to the signal processor 190 through the data bus 170. The data bus 170 may temporarily store and then output the pixel values (image signals) output from the ADC circuit 130. The data bus 170 may include a plurality of column memories and a column decoder. The plurality of pixel values stored in the plurality of column memories may be output to the signal processor 190 under the control of the column decoder.

The signal processor 190 may generate digital image data FDID by performing noise reduction processing, gain adjustment, waveform shaping processing, interpolation processing, white balance processing, gamma processing, edge enhancement processing, binning, etc. on image data. Unlike FIG. 1, the signal processor 190 may also be provided in a host device outside the image sensing device 100.

FIG. 2 is a circuit diagram for describing one of the pixels of the image sensing device.

Referring to FIG. 2, the pixel PX may include a first photodiode PD, a read circuit RC, a first capacitor C1, a second capacitor C2, and a plurality of transistors. The first photodiode PD may be connected to a first floating diffusion (FD) node FD1 through a first transfer transistor TT. The first transfer transistor TT may have one end connected to the first photodiode PD and the other end connected to the first FD node FD1, and may form a channel through which current may flow between the first photodiode PD and the first FD node FD1 in response to a first transfer control signal TS. For example, the first transfer transistor TT may provide charges generated in the first photodiode PD to the first FD node FD1. While an exposure operation is performed, charges generated in excess of the full well capacity (FWC) of the first photodiode PD may overflow to the first FD node FD1 regardless of the first transfer control signal TS.

The read circuit RC may include a source follower transistor SFT and a selection transistor SELT. The source follower transistor SFT may operate as a source follower amplifier based on a bias current and a third power supply voltage VPIX generated by a current source CS connected to the column line CL. The source follower transistor SFT may output a voltage corresponding to the charges transmitted to the first FD node FD1 as an output signal Vout to the column line CL through the selection transistor SELT according to a selection control signal RSS.

A conversion gain refers to a ratio at which the voltage of the FD node is converted by the charges accumulated in the FD node. The conversion gain may vary depending on the total capacitance of the FD node and capacitors. When the total capacitance of the FD node and capacitors increases, the conversion gain may decrease, and when the total capacitance of the FD node and capacitors decreases, the conversion gain may increase. The higher the conversion gain, the higher the ratio at which the charge is converted to the voltage. Therefore, when the conversion gain is large, it may be used for the operation of generating a pixel signal corresponding to a lower luminance, and when the conversion gain is small, it may be used for the operation of generating a pixel signal corresponding to a higher luminance.

A conversion gain transistor CGT may have one end connected to the first FD node FD1 and the other end connected to a second FD node FD2, and may form a channel through which current may flow between the first FD node FD1 and the second FD node FD2 in response to a conversion gain control signal CGS. The conversion gain transistor CGT may switch a conversion gain mode in response to the conversion gain control signal CGS. For example, when the conversion gain transistor CGT is turned on, a channel is formed between the first FD node FD1 and the second FD node FD2, which increases the total capacitance and thus may decrease the conversion gain. When the conversion gain transistor CGT is turned on, the conversion gain transistor CGT may operate in a low conversion gain (LCG) mode. Conversely, when the conversion gain transistor CGT is turned off, the conversion gain transistor CGT may operate in a high conversion gain (HCG) mode.

Since the conversion gain in the HCG mode is formed only by the capacitance of the first FD node FD1, and the conversion gain in the LCG mode is formed by the sum of the capacitances of the first FD node FD1, the second FD node FD2, and the first capacitor C1, a size of the conversion gain in the HCG mode is greater than that in the LCG mode. That is, since the amount of charges generated is small at a brightness of low luminance, it may be advantageous to operate in the HCG mode.

While an exposure operation is performed, the charges generated in excess of the full well capacity (FWC) of the first photodiode PD may overflow to the second FD node FD2 through the first FD node FD1 regardless of the conversion gain control signal CGS.

The first capacitor C1 may be connected between the second FD node FD2 and a second power supply voltage VC. The first capacitor C1 may include at least one of a metal-oxide-semiconductor capacitor (MOSCAP) capacitor, a Metal-Insulator-Metal (MIM) capacitor, and a parasitic capacitor formed by interaction between adjacent conductive lines. The first capacitor C1 may be different from a capacitor of the second FD node FD2 due to the capacitance component of the second FD node FD2 itself. A capacitance of the first capacitor C1 may be greater than a capacitance of the second FD node FD2.

A connection transistor CT may have one end connected to the second FD node FD2 and the other end connected to a third FD node FD3, and may form a channel through which current may flow between the second FD node FD2 and the third FD node FD3 in response to a connection control signal CS. For example, the connection transistor CT may provide charges from the second FD node FD2 to the third FD node FD3.

The second capacitor C2 may be positioned between a first power supply voltage VSC and the third FD node FD3. The second capacitor C2 may include at least one of a Metal-Insulator-Metal (MIM) capacitor and a MOSCAP capacitor. While the exposure operation is performed, the charges generated in excess of the full well capacity (FWC) of the first photodiode PD may overflow and be accumulated in the first capacitor C1, the charges exceeding the FWC of the first capacitor C1 may overflow to the third FD node FD3 through the connection transistor CT regardless of the connection control signal CS, and the overflowed charges may be accumulated in the third FD node FD3 and the second capacitor C2.

The reset transistor RT may reset the charges accumulated in at least one of the first FD node FD1, the second FD node FD2, the third FD node FD3, the first capacitor C1, and the second capacitor C2 according to a reset control signal RS. The reset transistor RT may have one end connected to the first power supply voltage VSC and the other end connected to the third FD node FD3, for example. The reset transistor RT may be connected in parallel to the second capacitor C2. The reset transistor RT may form a channel through which current may flow between the first power supply voltage VSC and the third FD node FD3 according to the reset control signal RS. Therefore, the reset transistor RT may quickly reset the second capacitor C2 having a large capacitance.

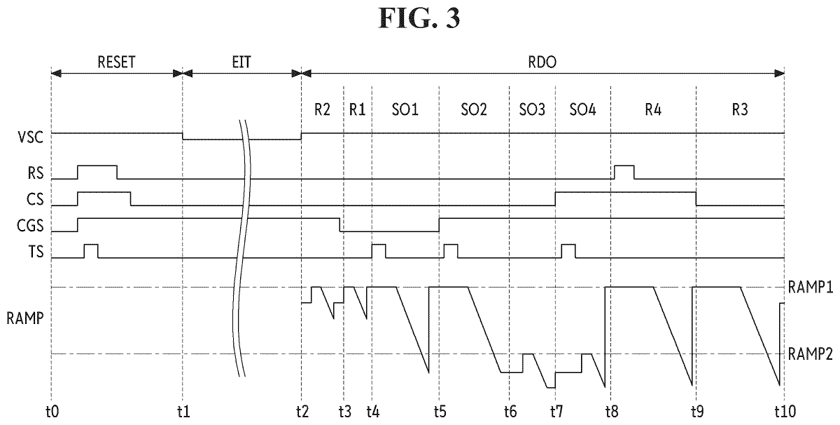

FIG. 3 is a timing diagram for describing an operation of the pixel of FIG. 2.

The timing diagram of FIG. 3 illustrates waveforms of control signals applied to gates of the transistors of FIG. 2. The waveforms of the coupling voltage VSC, the reset control signal RS, the connection control signal CS, the conversion gain control signal CGS, the first transfer control signal TS, and the ramp signal RAMP, among the control signals applied to the gates of the transistors, are illustrated in order. The control signals may be generated in the form of pulses in the row driver 120 under the control of the timing controller 150 of FIG. 1. Each pulse waveform, except for the coupling voltage VSC and the ramp signal RAMP, may toggle between a logic high voltage and a logic low voltage. The coupling voltage VSC may switch between a voltage of a first voltage level and a voltage of a second voltage level. The ramp signal RAMP may be a signal having a specific start level, end level, and slope based on preset parameters. The voltage of the logic high level may turn on the transistor, and the voltage of the logic low level may turn off the transistor. However, when some of the transistors constituting the pixel of FIG. 2 are configured as PMOS transistors according to an implementation of the disclosure, the pulse waveform may have a reversed form of the waveform illustrated in FIG. 3.

Hereinafter, an operation section of the pixel will be described in detail with reference to FIGS. 2 and 3. The operation section of the pixel may sequentially include a reset time section RESET, an exposure time section EIT, and a readout time section RDO.

The reset time section RESET (t0 to t1) may be a section for resetting the first to third FD nodes FD1 to FD3, the first and second capacitors C1 and C2, and the first photodiode PD. During the reset time section RESET, the row driver 120 may toggle the first transfer control signal TS, the conversion gain control signal CGS, the connection control signal CS, and the reset control signal RS from a logic low level to a logic high level. During the reset time section RESET, a reset voltage may be provided to the first to third FD nodes FD1 to FD3, the first and second capacitors C1 and C2, and the first photodiode PD.

The exposure time section EIT (t1 to t2) may be a time section during which charges are accumulated in the first photodiode PD by the received light. During the exposure time section EIT, the conversion gain control signal CGS may be maintained at a logic high level. The first transfer control signal TS, the connection control signal CS, and the reset control signal RS may be toggled to a logic low level.

During the exposure time section EIT, when the charges accumulated in the first photodiode PD exceed the full well capacity (FWC) of the first photodiode PD, the charges may overflow through the first transfer transistor TT and be accumulated in the first capacitor C1 via the first FD node FD1 and the conversion gain transistor CGT. When the overflowed charges exceed the FWC of the first capacitor C1, the charges may overflow through the connection transistor CT and be accumulated in the second capacitor C2 via the third FD node FD3.

In this case, during the exposure time section EIT, the conversion gain control signal CGS may be toggled to a logic low level. In this case, the charges exceeding the full well capacity (FWC) of the first photodiode PD may overflow through the first transfer transistor TT, may overflow again through the conversion gain transistor CGT, and be accumulated in the second FD node FD2 and the second capacitor C2.

For example, in the case of an NMOS transistor, an N-type doped source/drain region may be formed on a P-type doped substrate. In this case, the FD node may correspond to the source/drain region. Therefore, a PN junction may be formed between the FD node and the substrate. During the reset time section RESET, the reset voltage may be applied to the FD node, which may cause a negative bias to be applied to the PN junction between the FD node and the substrate. The negative bias formed at the PN junction may cause leakage current due to minority carriers. The magnitude of leakage current due to minority carriers may vary across the plurality of pixels, and such variation may cause dark signal non-uniformity (DSNU) noise. The DSNU noise degrades SNR characteristics and may significantly reduce the quality of images captured in a low luminance environment.

According to some implementations, to mitigate the DSNU noise, the coupling voltage VSC may be toggled from a second voltage level to a first voltage level during the exposure time section EIT. While not in the exposure time sections EIT (during the reset time section RESET and the readout time section RDO), the coupling voltage VSC may be maintained at the second voltage level. The first voltage level may be, for example, about 1.6 V, and the second voltage level may be, for example, about 2.8 V. However, this is an example, and the first and second voltage levels may have different values, but the second voltage level may be greater than the first voltage level. By lowering the voltage level of the coupling voltage VSC during the exposure time section EIT, the voltage level applied to the FD node may be lowered. This may reduce the leakage current due to the minority carriers. However, lowering the voltage level of the coupling voltage VSC may also simultaneously lower the FWC of the second capacitor C2.

The exposure time section EIT may be a time section that is 11 ms or longer to minimize a flicker phenomenon caused by LEDs used in traffic signals. The reset time section RESET or the readout time section RDO may be a time section that is much smaller than the exposure time section EIT, i.e., about 1,000 times smaller.

In the readout time section RDO (t2 to t10), a first sub-output signal SO1 and a first reset signal R1 may correspond to the high conversion gain (HCG) mode. The conversion gain in the HCG mode may be determined by the capacitance value of the first FD node FD1. A second sub-output signal SO2 and a second reset signal R2 may correspond to the low conversion gain (LCG) mode. The conversion gain in the LCG mode may be determined by the sum of the capacitance value of the first FD node FD1, the capacitance value of the second FD node FD2, and the capacitance value of the first capacitor C1. A third sub-output signal SO3 and a third reset signal R3 may correspond to a low conversion gain-lateral overflow (LCG-LOF) mode. The conversion gain in the LCG-LOF mode may be determined by the sum of the capacitance value of the first FD node FD1, the capacitance value of the second FD node FD2, and the capacitance value of the first capacitor C1. A fourth sub-output signal SO4 and a fourth reset signal R4 may correspond to a very low conversion gain-lateral overflow (VLCG-LOF) mode. The conversion gain in the VLCG-LOF mode may be determined by the sum of the capacitance values of the first to third FD nodes FD1, FD2, and FD3 and the capacitance values of the first and second capacitors C1 and C2. In conclusion, the conversion gain value in each mode may be largest in the HCG mode and smallest in the VLCG-LOF mode. The conversion gain values in the LCG mode and the LCG-LOF mode may be smaller than that in the HCG mode and greater than that in the VLCG-LOF mode. The conversion gain values in the LCG mode and the LCG-LOF mode may be the same as each other. Each sub-output signal SO1 to SO4 and reset signal R1 to R4 may be provided as Vout to the ADC block 130 of FIG. 1.

At t2 to t3, the pixel PX may turn on the conversion gain control signal CGS and output the second reset signal R2. At t3 to t4, the pixel PX may turn off the conversion gain control signal CGS and output the first reset signal R1. At t4 to t5, the pixel PX may turn on and then off the transfer control signal TS and output the first sub-output signal SO1. At t5 to t6, the pixel PX may turn on the conversion gain control signal CGS and output the second sub-output signal SO2. The ADC block 130 of FIG. 1 may generate a first digital signal by performing the first-type CDS using the first reset signal R1 and the first sub-output signal SO1, and may generate a second digital signal by performing the first-type CDS using the second reset signal R2 and the second sub-output signal SO2.

At t6 to t7, the pixel PX may output the third sub-output signal SO3. At t7 to t8, the pixel PX may turn on the connection control signal CS and output the fourth sub-output signal SO4. A start level RAMP2 of the ramp signal RAMP when outputting the third sub-output signal SO3 and the fourth sub-output signal SO4 (t6 to t8) may be lower than a start level RAMP1 of the ramp signal RAMP when outputting the first sub-output signal SO1 and the second sub-output signal SO2 (t4 to t6). At t8 to t9, the pixel PX may turn on and then off the reset control signal RS and output the fourth reset signal R4. At t9 to t10, the pixel PX may turn off the connection control signal CS and output the third reset signal R3. The ADC block 130 of FIG. 1 may generate a third digital signal by performing the second-type CDS using the third reset signal R3 and the third sub-output signal SO3, and may generate a fourth digital signal by performing the second-type CDS using the fourth reset signal R4 and the fourth sub-output signal SO4.

The data bus 170 of FIG. 1 may receive the first to fourth digital signals from the ADC block 130 of FIG. 1, temporarily store the first to fourth digital signals, align the first to fourth digital signals, and then output the first to fourth digital signals to the signal processor 190 of FIG. 1. The signal processor 190 may merge the first to fourth digital signals to generate digital image data FDID.

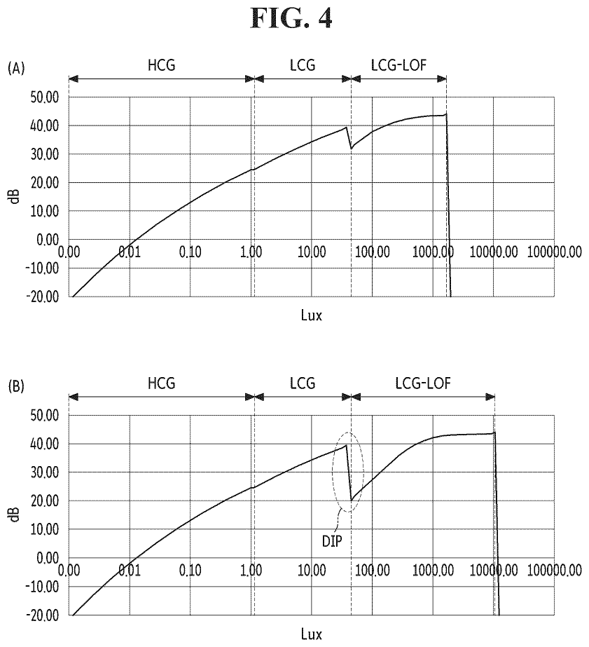

FIG. 4 is a graph illustrating a signal to noise ratio of a pixel according to changes in luminance. In the graph of FIG. 4, an x-axis represents the change in size of luminance (Lux). A y-axis represents a signal to noise ratio.

Referring to FIG. 4, a graph (A) illustrates the signal to noise ratio according to the change in luminance of pixels with the HCG, LCG, and LCG-LOF modes, and a graph (B) illustrates the signal to noise ratio according to the change in luminance of pixels with an increased capacitance value of lateral overflow integrated capacitor (LOFIC) (which may correspond to the second capacitor C2 in FIG. 2) for dynamic range expansion in the pixels with HCG, LCG, and LCG-LOF modes. When increasing the capacitance value of the LOFIC to expand the dynamic range, a deep SNR dip may occur when switching from the LCG mode to the LCG-LOF mode. In general, to obtain an image in which noise may not be identified with the naked eye, it is required to maintain an SNR of approximately 30 dB or higher, but it may be confirmed that the SNR decreases to approximately 20 dB at the SNR dip. The SNR dip may make it difficult to increase the capacitance value of the LOFIC to secure a wide dynamic range in the pixels with the HCG, LCG, and LCG-LOF modes. In addition, applying a voltage of a low voltage level during the exposure time section to reduce DSNU noise may lower the FWC of the LOFIC, which may also make it difficult to secure a wide dynamic range.

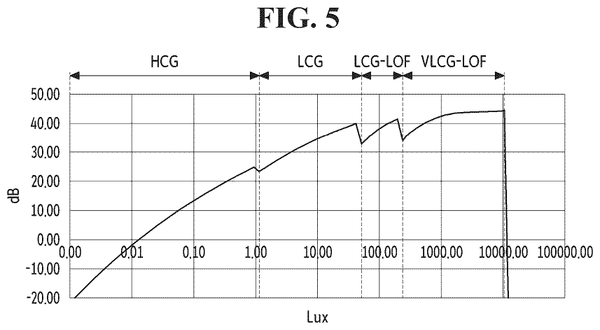

FIG. 5 is a graph illustrating a signal-to-noise ratio of a pixel according to changes in luminance. In the graph of FIG. 5, an x-axis represents the change in size of luminance (Lux). A y-axis represents a signal to noise ratio.

The graph in FIG. 5 illustrates the signal to noise ratio according to the change in luminance of pixels with the HCG, LCG, LCG-LOF, and VLCG-LOF modes according to some implementations of the present disclosure. According to some implementations, the pixel PX may have the HCG, LCG, LCG-LOF, and VLCG-LOF modes as the conversion gain mode. By further adding one step of conversion gain mode, it may be confirmed that the SNR of about 30 dB or more is maintained even when the capacitance value of the LOFIC (which may correspond to the second capacitor C2 in FIG. 2) is increased to secure a wide dynamic range.

In addition, according to some implementations, by further adding one step of conversion gain mode, that is, by further securing the LCG-LOF mode with a conversion gain greater than the VLCG-LOF mode, which accumulates the overflowed charges exceeding the FWC in the photodiode through the second FD node FD2 and the first capacitor C1, the lower limit charge amount of a charge coverage range of the VLCG-LOF mode may be increased. Therefore, the influence of DSNU noise occurring in proportion to the size of the negative bias may be alleviated. As a result, the need to significantly lower the voltage level applied to the FD node during the exposure time section may be reduced. This may alleviate the decrease in FWC of the LOFIC (which may correspond to the second capacitor C2 in FIG. 2) that occurs as a result of significantly lowering the voltage level applied to the FD node.

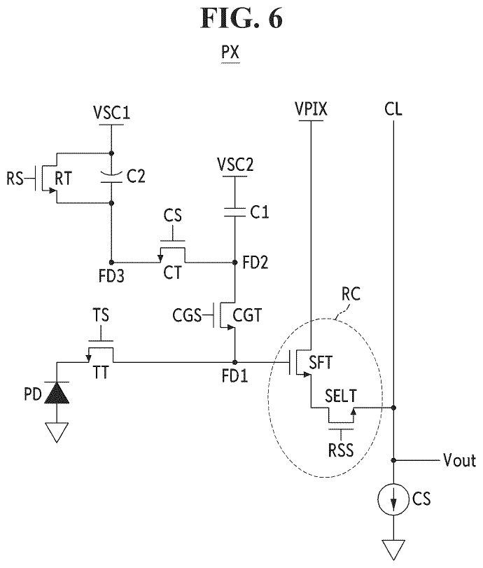

FIG. 6 is a circuit diagram for describing one of the pixels of the image sensing device.

In FIG. 6, a detailed description of the content overlapping FIG. 2 will be omitted. Referring to FIG. 6, the pixel PX may include a first photodiode PD, a read circuit RC, a first capacitor C1, a second capacitor C2, and a plurality of transistors. The first photodiode PD may be connected to a first floating diffusion (FD) node FD1 through a transfer transistor TT. The transfer transistor TT may have one end connected to the first photodiode PD and the other end connected to the first FD node FD1, and may form a channel through which current may flow between the first photodiode PD and the first FD node FD1 in response to a first transfer control signal TS. For example, the transfer transistor TT may provide charges generated in the first photodiode PD to the first FD node FD1.

The read circuit RC may include a source follower transistor SFT and a selection transistor SELT. The source follower transistor SFT may operate as a source follower amplifier based on a bias current and a third power supply voltage VPIX generated by a current source CS connected to the column line CL. The source follower transistor SFT may output a voltage corresponding to the charges transmitted to the first FD node FD1 as an output signal Vout to the column line CL through the selection transistor SELT according to a selection control signal RSS.

A conversion gain transistor CGT may have one end connected to the first FD node FD1 and the other end connected to a second FD node FD2, and may form a channel through which current may flow between the first FD node FD1 and the second FD node FD2 in response to a conversion gain control signal CGS. The conversion gain transistor CGT may switch a conversion gain mode in response to the conversion gain control signal CGS.

Unlike in FIG. 2, the first capacitor C1 may be connected between the second FD node FD2 and a second coupling voltage VSC2. The first capacitor C1 may include at least one of a MOSCAP capacitor, a Metal-Insulator-Metal (MIM) capacitor, and a parasitic capacitor formed by interaction between adjacent conductive lines. The first capacitor C1 may be different from a capacitor of the second FD node FD2 due to the capacitance component of the second FD node FD2 itself. A capacitance of the first capacitor C1 may be greater than a capacitance of the second FD node FD2.

A connection transistor CT may have one end connected to the second FD node FD2 and the other end connected to a third FD node FD3, and may form a channel through which current may flow between the second FD node FD2 and the third FD node FD3 in response to a connection control signal CS. For example, the connection transistor CT may provide charges from the second FD node FD2 to the third FD node FD3.

The second capacitor C2 may be positioned between a first power supply voltage VSC and the third FD node FD3. The second capacitor C2 may include at least one of a Metal-Insulator-Metal (MIM) capacitor and a MOSCAP capacitor.

The reset transistor RT may reset the charges accumulated in at least one of the first FD node FD1, the second FD node FD2, the third FD node FD3, the first capacitor C1, and the second capacitor C2 according to a reset control signal RS.

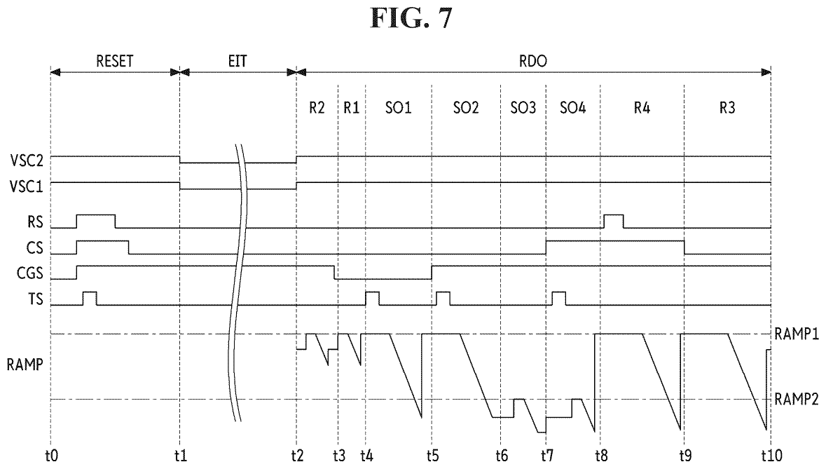

FIG. 7 is a timing diagram for describing an operation of the pixel of FIG. 6.

In FIG. 7, a detailed description of the content overlapping FIG. 3 will be omitted. Referring to FIG. 7, the timing diagram of FIG. 7 illustrates waveforms of control signals applied to gates of the transistors of FIG. 6. Unlike the timing diagram of FIG. 3, the waveforms of the first power supply voltage VSC1, the second coupling voltage VSC2, the reset control signal RS, the connection control signal CS, the conversion gain control signal CGS, and the first transfer control signal TS, among the control signals applied to the gates of the transistors, are illustrated. The control signals may be generated in the form of pulses in the row driver 120 under the control of the timing controller 150 of FIG. 1. Each pulse waveform, except for the first and second coupling voltages VSC1 and VSC2, may toggle between a logic high voltage and a logic low voltage. The first power supply voltage VSC1 may toggle between a voltage of a first voltage level and a voltage of a second voltage level. The second coupling voltage VSC2 may toggle between a voltage of a third voltage level and a voltage of a fourth voltage level. The voltage of the logic high level may turn on the transistor, and the voltage of the logic low level may turn off the transistor. However, when some of the transistors constituting the pixel of FIG. 6 are configured as PMOS transistors according to an implementation of the disclosure, the pulse waveform may have a reversed form of the waveform illustrated in FIG. 7.

Hereinafter, an operation section of the pixel will be described in detail with reference to FIGS. 6 and 7. The operation section of the pixel may sequentially include a reset time section RESET, an exposure time section EIT, and a readout time section RDO.

The reset time section RESET (t0 to t1) may be a section for resetting the first to third FD nodes FD1 to FD3, the first and second capacitors C1 and C2, and the first photodiode PD. During the reset time section RESET, the row driver 120 may toggle the first transfer control signal TS, the conversion gain control signal CGS, the connection control signal CS, and the reset control signal RS from a logic low level to a logic high level. During the reset time section RESET, a reset voltage may be provided to the first to third FD nodes FD1 to FD3, the first and second capacitors C1 and C2, and the first photodiode PD.

The exposure time section EIT (t1 to t2) may be a time section during which charges are accumulated in the first photodiode PD by the received light. During the exposure time section, the conversion gain control signal CGS may be maintained at a logic high level. The first transfer control signal TS, the connection control signal CS, and the reset control signal RS may be toggled to a logic low level.

As described above, the PN junction may be formed between the FD node and the substrate, and the negative bias between the FD node and the substrate may cause the leakage current due to minority carriers. The leakage current due to minority carriers may be one of the causes of DSNU noise. According to some implementations, the pixel PX may operate in the HCG, LCG, LCG-LOF, and VLCG-LOF modes, and in the LCG-LOF and VLCG-LOF modes, management of leakage current of different FD nodes may be required.

According to some implementations, to mitigate the DSNU noise, during the exposure time section EIT, the first power supply voltage VSC1 may be toggled from a second voltage level to a first voltage level, and the second coupling voltage VSC2 may be toggled from a fourth voltage level to a third voltage level. The third and fourth voltage levels are substantially identical to the first and second voltage levels, respectively, but may be different depending on the implementation of the disclosure. While not in the exposure time section EIT (during the reset time section RESET and readout time section RDO), the first power supply voltage VSC1 may be maintained at the second voltage level, and the second coupling voltage VSC2 may be maintained at the fourth voltage level. The first and third voltage levels may be, for example, about 1.6 V, and the second and fourth voltage levels may be, for example, about 2.8 V. However, this is an example, and the first to fourth voltage levels may have different values. By lowering the voltage levels of the first and second coupling voltages VSC1 and VSC2 during the exposure time section EIT, the voltage levels applied to the second and third FD nodes FD2 and FD3 may be lowered. In conclusion, management of leakage current of different FD nodes (e.g., the second FD node FD2 and the third FD node FD3) may be performed in the LCG-LOF and VLCG-LOF modes, respectively.

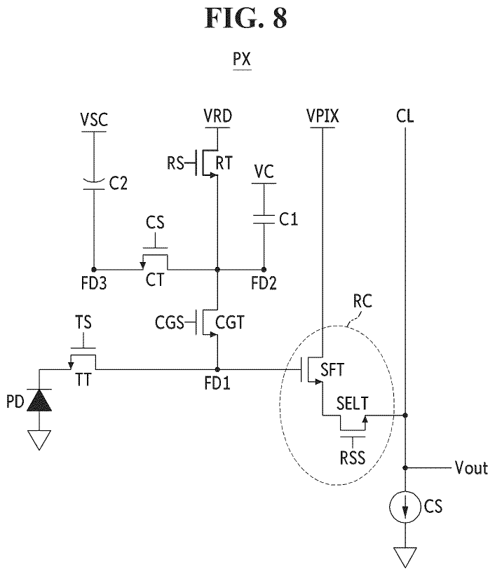

FIG. 8 is a circuit diagram for describing one of the pixels of the image sensing device.

In FIG. 8, a detailed description of the content overlapping FIG. 2 will be omitted. Referring to FIG. 8, the pixel PX may include a first photodiode PD, a read circuit RC, a first capacitor C1, a second capacitor C2, and a plurality of transistors. The first photodiode PD may be connected to a first floating diffusion (FD) node FD1 through a transfer transistor TT. The transfer transistor TT may have one end connected to the first photodiode PD and the other end connected to the first FD node FD1, and may form a channel through which current may flow between the first photodiode PD and the first FD node FD1 in response to a first transfer control signal TS. For example, the first transfer transistor TT may provide charges generated in the first photodiode PD to the first FD node FD1. While an exposure operation is performed, charges generated in excess of the full well capacity (FWC) of the first photodiode PD may overflow to the first FD node FD1 regardless of the first transfer control signal TS.

The read circuit RC may include a source follower transistor SFT and a selection transistor SELT. The source follower transistor SFT may operate as a source follower amplifier based on a bias current and a third power supply voltage VPIX generated by a current source CS connected to the column line CL. The source follower transistor SFT may output a voltage corresponding to the charges transmitted to the first FD node FD1 as an output signal Vout to the column line CL through the selection transistor SELT.

A conversion gain transistor CGT may have one end connected to the first FD node FD1 and the other end connected to a second FD node FD2, and may form a channel through which current may flow between the first FD node FD1 and the second FD node FD2 in response to a conversion gain control signal CGS. The conversion gain transistor CGT may switch a conversion gain mode in response to the conversion gain control signal CGS. For example, when the conversion gain transistor CGT is turned on, a channel is formed between the first FD node FD1 and the second FD node FD2, which increases the total capacitance and thus may decrease the conversion gain.

While an exposure operation is performed, the charges generated in excess of the full well capacity (FWC) of the first photodiode PD may overflow to the second FD node FD2 through the first FD node FD1 regardless of the conversion gain control signal CGS.

The first capacitor C1 may include at least one of a Metal-Insulator-Metal (MIM) capacitor and a MOSCAP capacitor formed by interaction between conductive lines. The first capacitor C1 may be different from a capacitor of the second FD node FD2 due to the capacitance component of the second FD node FD2 itself. A capacitance of the first capacitor C1 may be greater than a capacitance of the second FD node FD2.

A connection transistor CT may have one end connected to the second FD node FD2 and the other end connected to a third FD node FD3, and may form a channel through which current may flow between the second FD node FD2 and the third FD node FD3 in response to a connection control signal CS. For example, the connection transistor CT may provide charges from the second FD node FD2 to the third FD node FD3.

The second capacitor C2 may be positioned between a first power supply voltage VSC and the third FD node FD3. The second capacitor C2 may include at least one of a Metal-Insulator-Metal (MIM) capacitor and a MOSCAP capacitor. While the exposure operation is performed, the charges generated in excess of the full well capacity (FWC) of the first photodiode PD may overflow and be accumulated in the first capacitor C1, the charges exceeding the FWC of the first capacitor C1 may overflow to the third FD node FD3 regardless of the connection control signal CS through the connection transistor CT, and the overflowed charges may be accumulated in the third FD node FD3 and the second capacitor C2.

Unlike in FIG. 2, the reset transistor RT may have one end connected to the second FD node FD2 and the other end connected to a reset voltage VRD. The reset transistor RT may reset the accumulated charges by providing the reset voltage VRD to at least one of the first FD node FD1, the second FD node FD2, the third FD node FD3, the first capacitor C1, and the second capacitor C2 according to a reset control signal RS.

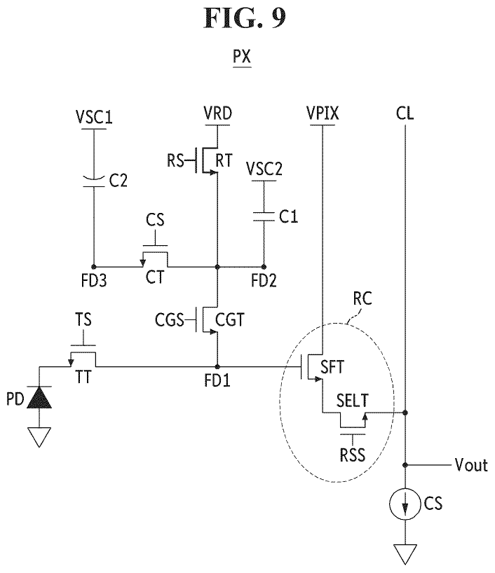

FIG. 9 is a circuit diagram for describing one of the pixels of the image sensing device.

In FIG. 9, a detailed description of the content overlapping FIG. 8 will be omitted. Referring to FIG. 9, the pixel PX may include a first photodiode PD, a read circuit RC, a first capacitor C1, a second capacitor C2, and a plurality of transistors. The first photodiode PD may be connected to a first floating diffusion (FD) node FD1 through a transfer transistor TT. The transfer transistor TT may have one end connected to the first photodiode and the other end connected to the first FD node FD1, and may form a channel through which current may flow between the first photodiode PD and the first FD node FD1 in response to a first transfer control signal TS.

The read circuit RC may include a source follower transistor SFT and a selection transistor SELT. The source follower transistor SFT may operate as a source follower amplifier based on a bias current and a third power supply voltage VPIX generated by a current source CS connected to the column line CL. The source follower transistor SFT may output a voltage corresponding to the charges transmitted to the first FD node FD1 as an output signal Vout to the column line CL through the selection transistor SELT.

A conversion gain transistor CGT may have one end connected to the first FD node FD1 and the other end connected to a second FD node FD2, and may form a channel through which current may flow between the first FD node FD1 and the second FD node FD2 in response to a conversion gain control signal CGS.

Unlike in FIG. 8, the first capacitor C1 may be connected between the second FD node FD2 and the second coupling voltage VSC2. The first capacitor C1 may include at least one of a MOSCAP capacitor, a Metal-Insulator-Metal (MIM) capacitor, and a parasitic capacitor formed by interaction between adjacent conductive lines. The first capacitor C1 may be different from a capacitor of the second FD node FD2 due to the capacitance component of the second FD node FD2 itself. A capacitance of the first capacitor C1 may be greater than a capacitance of the second FD node FD2.

A connection transistor CT may have one end connected to the second FD node FD2 and the other end connected to a third FD node FD3, and may form a channel through which current may flow between the second FD node FD2 and the third FD node FD3 in response to a connection control signal CS.

The second capacitor C2 may be positioned between a first power supply voltage VSC and the third FD node FD3. The second capacitor C2 may include at least one of a Metal-Insulator-Metal (MIM) capacitor and a MOSCAP capacitor.

The reset transistor RT may have one end connected to the second FD node FD2 and the other end connected to the reset voltage VRD. The reset transistor RT may reset the accumulated charges by providing the reset voltage VRD to at least one of the first FD node FD1, the second FD node FD2, the third FD node FD3, the first capacitor C1, and the second capacitor C2 according to a reset control signal RS.

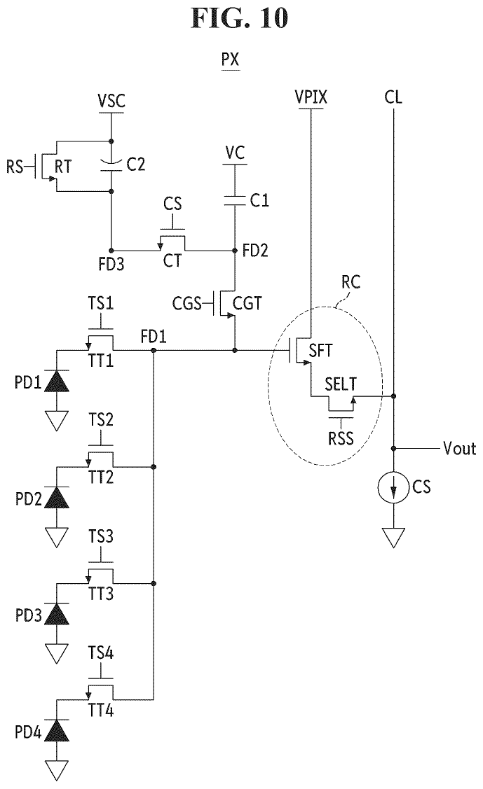

FIG. 10 is a circuit diagram for describing one of the pixels of the image sensing device.

Referring to FIG. 10, unlike FIG. 2, the pixel PX may further include second to fourth photodiodes PD2 to PD4. Although four photodiodes are illustrated in FIG. 10, the pixel PX may include a different number of photodiodes depending on the implementation of the disclosure. The first to fourth photodiodes PD1 to PD4 may be connected to the first floating diffusion (FD) node FD1 through first to fourth transfer transistors TT1 to TT4, respectively. Each of the first to fourth transfer transistors TT1 to TT4 may have one end connected to the first to fourth photodiodes PD1 to PD4 and the other end connected to the first FD node FD1, respectively, and may form a channel through which current may flow between each of the photodiodes PD1 to PD4 and the first FD node FD1 in response to first to fourth transfer control signals TS1 to TS4. For example, the first to fourth transfer transistors TT1 to TT4 may each provide charges generated in the first to fourth photodiodes PD1 to PD4 to the first FD node FD1. While an exposure operation is performed, charges generated in excess of the full well capacity (FWC) of the first to fourth photodiodes PD1 to PD4 may overflow to the first FD node FD1 regardless of the first to fourth transfer control signals TS1 to TS4.

The read circuit RC may include a source follower transistor SFT and a selection transistor SELT. The source follower transistor SFT may operate as a source follower amplifier based on a bias current and a third power supply voltage VPIX generated by a current source CS connected to the column line CL. The source follower transistor SFT may output a voltage corresponding to the charges transmitted to the first FD node FD1 as an output signal Vout to the column line CL through the selection transistor SELT according to a selection control signal RSS.

A conversion gain transistor CGT may have one end connected to the first FD node FD1 and the other end connected to a second FD node FD2, and may form a channel through which current may flow between the first FD node FD1 and the second FD node FD2 in response to a conversion gain control signal CGS. The conversion gain transistor CGT may switch a conversion gain mode in response to the conversion gain control signal CGS.

While an exposure operation is performed, the charges generated in excess of the full well capacity (FWC) of the first to fourth photodiodes PD1 to PD4 may overflow to the second FD node FD2 through the first FD node FD1 regardless of the conversion gain control signal CGS.

The first capacitor C1 may be connected between the second FD node FD2 and a second power supply voltage VC. The first capacitor C1 may include at least one of a MOSCAP capacitor, a Metal-Insulator-Metal (MIM) capacitor, and a parasitic capacitor formed by interaction between adjacent conductive lines. The first capacitor C1 may be different from a capacitor of the second FD node FD2 due to the capacitance component of the second FD node FD2 itself. A capacitance of the first capacitor C1 may be greater than a capacitance of the second FD node FD2.

A connection transistor CT may have one end connected to the second FD node FD2 and the other end connected to a third FD node FD3, and may form a channel through which current may flow between the second FD node FD2 and the third FD node FD3 in response to a connection control signal CS. For example, the connection transistor CT may provide charges from the second FD node FD2 to the third FD node FD3.

The second capacitor C2 may be positioned between a first power supply voltage VSC and the third FD node FD3. The second capacitor C2 may include at least one of a Metal-Insulator-Metal (MIM) capacitor and a MOSCAP capacitor.

The reset transistor RT may reset the charges accumulated in at least one of the first FD node FD1, the second FD node FD2, the third FD node FD3, the first capacitor C1, and the second capacitor C2 according to a reset control signal RS.

As used herein, the term “at least one of” can refer to and encompass any and all possible combinations of one or more of the associated listed terms. For example, the term “at least one of A, B, or C” means that (i) at least one of A, (ii) at least one of B, (iii) at least one of C, (iv) at least one of A and at least one of B, (v) at least one of B and at least one of C, (vi) at least one of A and at least one of C, or (vi) at least one of A, at least one of B and at least one of C are possible, where A, B and C may be singular or plural.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. An image sensing device comprising a plurality of pixels,
wherein each of the plurality of pixels includes:
a first photodiode;
a transfer transistor having a first end connected to the first photodiode and a second end connected to a first floating diffusion (FD) node;
a conversion gain transistor having a first end connected to the first FD node and a second end connected to a second FD node;
a first capacitor connected to the second FD node;
a connection transistor having a first end connected to the second FD node and a second end connected to a third FD node;
a second capacitor having a first end connected to the third FD node and a second end connected to a first power supply voltage; and
a reset transistor having a first end connected to the third FD and a second end connected to the first power supply voltage,
wherein the reset transistor is connected in parallel to the second capacitor.

2. The image sensing device of claim 1, wherein the first capacitor is connected to a second power supply voltage different from the first power supply voltage.

3. The image sensing device of claim 1, wherein the second capacitor is at least one of a Metal-Insulator-Metal (MIM) capacitor and a MOSCAP capacitor.

4. The image sensing device of claim 2, wherein the second capacitor is configured to receive a first voltage from the first power supply voltage and receive a second voltage from the first power supply voltage, and
wherein the second voltage is different from the first voltage.

5. The image sensing device of claim 4, wherein the first capacitor is configured to receive a third voltage from the second power supply voltage and receive a fourth voltage from the second power supply voltage, and
wherein the fourth voltage is different from the third voltage.

6. The image sensing device of claim 1, wherein a capacitance of the first capacitor is greater than a capacitance of the second FD node.

7. The image sensing device of claim 1, wherein the first capacitor includes at least one of a metal-insulator-metal (MIM) capacitor, a metal-oxide-semiconductor capacitor (MOSCAP) capacitor, or a parasitic capacitor that is based on an interaction between adjacent conductive lines.

8. The image sensing device of claim 2, wherein each of the plurality of pixels further comprises:
a source follower transistor connected to the first FD and a third power supply voltage,
wherein the third power supply voltage is different from the first power supply voltage.

9. The image sensing device of claim 2, wherein each of the plurality of pixels further comprises:
a source follower transistor connected to the first FD and a third power supply voltage,
wherein the third power supply voltage is different from the second power supply voltage.

10. An image sensing device comprising a plurality of pixels,
wherein each of the plurality of pixels includes:
a first photodiode;
first to third floating diffusion (FD) nodes;
a first capacitor; and
a second capacitor having a larger capacitance than the first capacitor, and
wherein each of the plurality of pixels is configured to sequentially output
a first reset signal,
a second reset signal,
a first sub-output signal corresponding to the second reset signal, the first sub-output signal being based on converting charges in the first FD node with a first conversion gain,
a second sub-output signal corresponding to the first reset signal, the second sub-output signal being based on converting charges in the first and second FD nodes with a second conversion gain, the second conversion gain being smaller than the first conversion gain,
a third sub-output signal based on converting charges in the first and second FD nodes and the first capacitor with a third conversion gain, the third conversion gain being the same as the second conversion gain,
a fourth sub-output signal based on converting charges in the first FD node, the second FD node, the third FD node, and the first and second capacitors with a fourth conversion gain, the fourth conversion gain being smaller than the third conversion gain,
a third reset signal corresponding to the fourth sub-output signal, and
a fourth reset signal corresponding to the third sub-output signal.

11. The image sensing device of claim 10, wherein each of the plurality of pixels includes:
a first transfer transistor having a first end connected to the first photodiode and a second end connected to the first FD node;
a conversion gain transistor having a first end connected to the first FD node and a second end connected to the second FD node; and
a connection transistor having a first end connected to the second FD node and a second end connected to the third FD node, and
wherein the first capacitor has a first end connected to the second FD node, and the second capacitor has a first end connected to the third FD node.

12. The image sensing device of claim 11, wherein each of the plurality of pixels is configured to turn on the conversion gain transistor to output the first reset signal, the third reset signal, the fourth reset signal, the first sub-output signal, the third sub-output signal, and the fourth sub-output signal.

13. The image sensing device of claim 11, wherein each of the plurality of pixels is configured to turn off the conversion gain transistor to output the second reset signal and the second sub-output signal.

14. The image sensing device of claim 11, wherein each of the plurality of pixels is configured to turn on the connection transistor to output the fourth reset signal and the fourth sub-output signal.

15. The image sensing device of claim 11, wherein each of the plurality of pixels is configured to turn off the connection transistor to output the first reset signal, the second reset signal, the third reset signal, the first sub-output signal, the second sub-output signal, and the third sub-output signal.

16. An image sensing device comprising:
a plurality of pixels,
wherein each of the plurality of pixels includes:
a first photodiode;
a transfer transistor having a first end connected to the first photodiode and a second end connected to a first floating diffusion (FD) node;
a conversion gain transistor having a first end connected to the first FD node and a second end connected to a second FD node;
a first capacitor connected to the second FD node, the first capacitor being configured to store charges from the second FD node;
a connection transistor having a first end connected to the second FD node and a second end connected to a third FD node; and
a second capacitor having a first end connected to the third FD node and a second end connected to a first power supply voltage, the second capacitor being configured to store charges from the third FD node,
wherein each of the plurality of pixels is configured to sequentially output:
a first reset signal,
a second reset signal,
a first sub-output signal corresponding to the second reset signal, the first sub-output signal being based on converting charges in the first FD node with a first conversion gain,
a second sub-output signal corresponding to the first reset signal, the second sub-output signal being based on converting charges in the first and second FD nodes with a second conversion gain smaller than the first conversion gain,
a third sub-output signal being based on converting charges in the first and second FD nodes and the first capacitor with a third conversion gain, the third conversion gain being the same as the second conversion gain,
a fourth sub-output signal being based on converting charges in the first FD node, the second FD node, the third FD node, and the first and second capacitors with a fourth conversion gain, the fourth conversion gain being smaller than the third conversion gain,
a third reset signal corresponding to the fourth sub-output signal, and
a fourth rest signal corresponding to the third sub-output signal.

17. The image sensing device of claim 16, wherein each of the plurality of pixels includes a reset transistor, the reset transistor has a first end connected to the third FD node and a second end connected to the first power supply voltage, and the reset transistor is connected in parallel to the second capacitor.

18. The image sensing device of claim 16, wherein each of the plurality of pixels includes a reset transistor, and the reset transistor has a first end connected to the second FD node and a second end connected to a reset voltage.

19. The image sensing device of claim 16, wherein the image sensing device is configured to:
set the first power supply voltage to a first voltage level in an exposure time section during which an exposure operation is performed, and
set the first power supply voltage to a second voltage level that is higher than the first voltage level outside the exposure time section.

20. The image sensing device of claim 19, wherein the first capacitor has a first end connected to the second FD node and a second end connected to a second coupling voltage, and
wherein the image sensing device is configured to:
set the second coupling voltage to a third voltage level in the exposure time section, and
set the second coupling voltage to a fourth voltage level that is higher than the third voltage level outside the exposure time section.
